(19) United States
(12) Patent Application Publication
(10) Pub. No.: US 2025/0074585 A1
(43) Pub. Date: Mar. 6, 2025

(54) Electric Vertical Take Off and Landing Hybrid Aircraft

(71) Applicant: Michael D. Benson, Victoria, MN (US)

(72) Inventor: Michael D. Benson, Victoria, MN (US)

(21) Appl. No.: 18/364,128

(22) Filed: Aug. 28, 2023

(51) Int. Cl. B64C 29/00; B64D 27/30

(52) U.S. Cl. CPC B64C 29/0075; B64D 27/31; B64D 27/33

(57) ABSTRACT

This aircraft is a Vertical Take Off and Landing Fighter type. The primary power source will be a low bypass jet turbine/engine. The auxiliary power source will be provided by axial flux electric motors. These motors will be housed in a moveable section, the EVTOL apparatus, that houses multiple turbines. These moveable sections will be attached to sides of the fuselage, extending into the dual wing. These moveable sections will move to a vertical position during take-off and landing; and be in a horizontal position during normal flight. These moveable sections will have an intake area aft, and vectoring thrust at the rear. This aircraft is a hybrid utilizing a gas jet turbine and electrical axial flux motors. The EVTOL apparatus is a compact self-contained unit capable of generating thrust through a turbine driven by Axial Flux electric motors.

### TECHNICAL FIELD

The subject matter disclosed herein relates to an Electric Vertical Take-off and Landing Hybrid aircraft.

### SUMMARY

This aircraft is a Vertical Take Off and Landing fighter type. The primary power source will be a low bypass jet turbine. The auxiliary power source will be provided by axial flux electric motors. These motors will be housed in a moveable section that houses multiple turbines. These moveable sections will be attached to sides of the fuselage, extending into the wing. These moveable sections will move to a vertical position during take-off and landing; and be in a horizontal position during normal flight. These moveable sections will have an intake area aft, and vectoring thrust at the rear. These moveable sections will be referred to as then EVTOL apparatus.

The low bypass jet turbine will generate thrust and electrical current. The electrical current will provide power to the axial flux motors. The thrust generated by the axial motor/turbines will assist in getting the aircraft off the surface. Once the aircraft is at a safe altitude the EVTOL apparatus will move from the vertical position to the horizontal position. These motors will assist by adding additional thrust to the aircraft. The EVTOL apparatus will contain a baffle assembly to close the intake portion when in supersonic flight. The axial flux motor/turbines will need to be in an off/idle configuration to avoid damage when in supersonic flight.

### BRIEF DESCRIPTION OF THE DRAWINGS

FIG. 1 depicts the top view of the aircraft.

FIG. 2 depicts the top view with the EVTOL apparatus deployed in the vertical/take off/landing position.

FIG. 3 depicts the side view of the aircraft.

FIG. 4 depicts the side view of the aircraft with the EVTOL apparatus deployed in the vertical/take off/landing position.

FIG. 5 depicts the front view of the aircraft.

FIG. 6 depicts the front view of the aircraft with the EVTOL apparatus deployed in the vertical/take off/landing position.

FIG. 7 depicts a side, top and exploded view of the EVTOL apparatus.

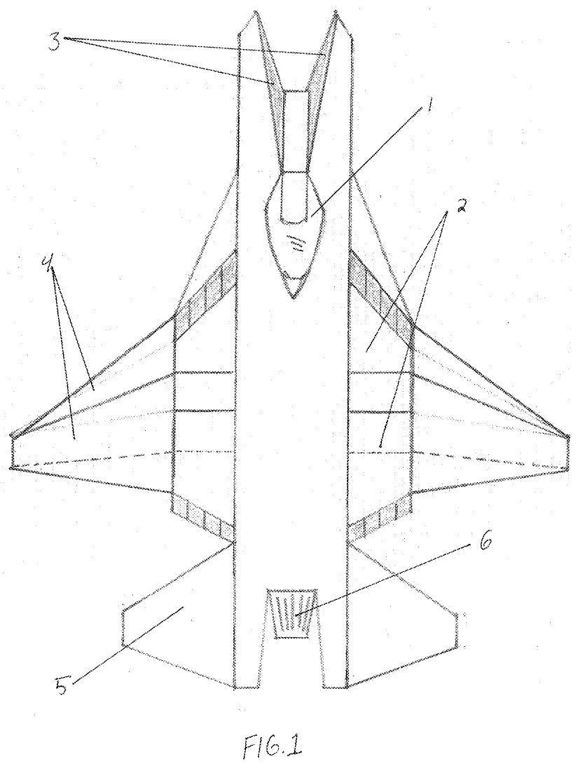

FIG. 1:
1-Canopy/Cockpit
2-EVTOL apparatus
3-Intake for low bypass jet turbine
4-Dual Wing
5-Elevator/Horizontal stabilizer
6-Exhaust for low bypass jet turbine

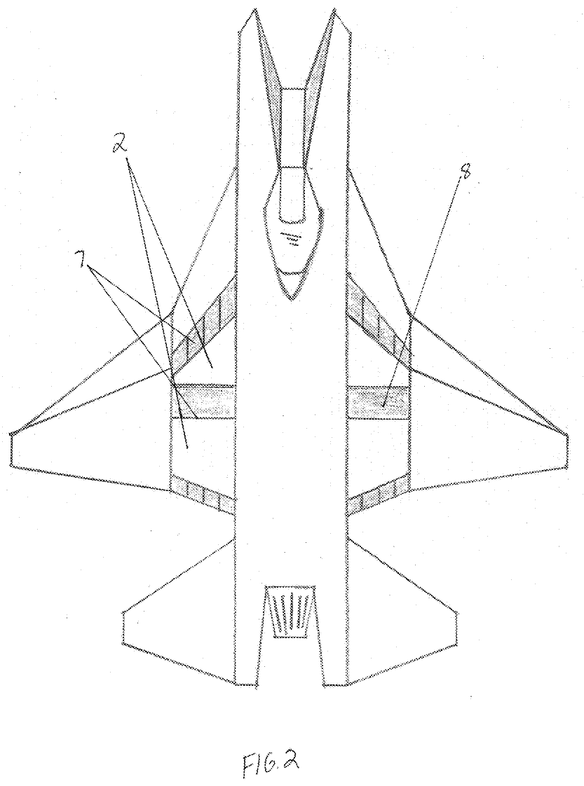

FIG. 2:
2-EVTOL apparatus
7-Intake for EVTOL apparatus
8-Lower portion of wing [exposed when EVTOL deployed]

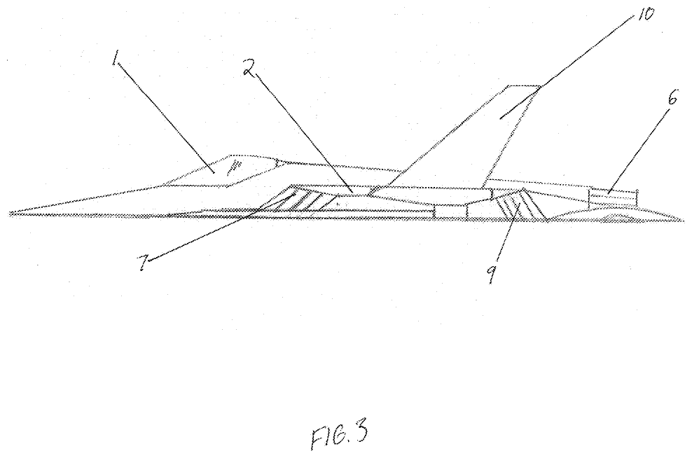

FIG. 3:
1-Canopy/Cockpit
2-EVTOL apparatus
6-Exhaust for low bypass jet turbine
7-Intake for EVTOL apparatus
9-Vectoring Thrust for EVTOL apparatus
10-Tail/Vertical stabilizer

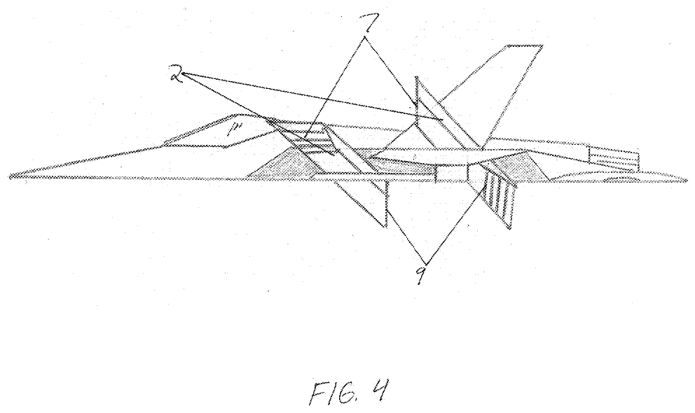

FIG. 4:
2-EVTOL apparatus
7-Intake for EVTOL apparatus
9-Vectoring Thrust for EVTOL apparatus

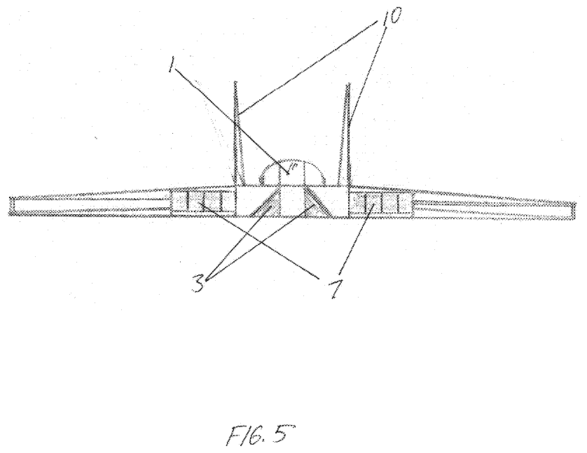

FIG. 5:
1-Canopy/Cockpit
3-Intake for low bypass jet turbine
7-Intake for EVTOL apparatus
10-Tail/Vertical Stabilizer

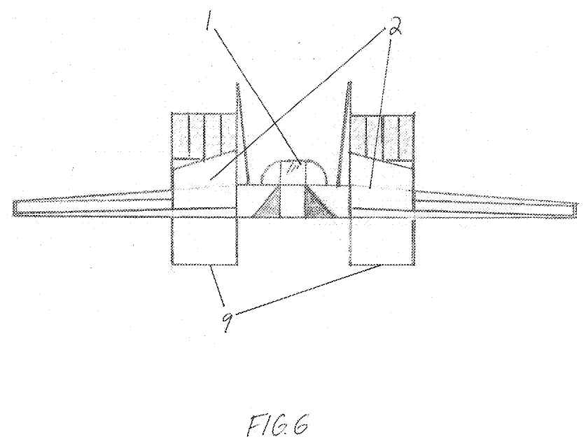

FIG. 6:
1-Canopy/Cockpit
2-EVTOL apparatus
9-Vectoring Thrust for EVTOL apparatus

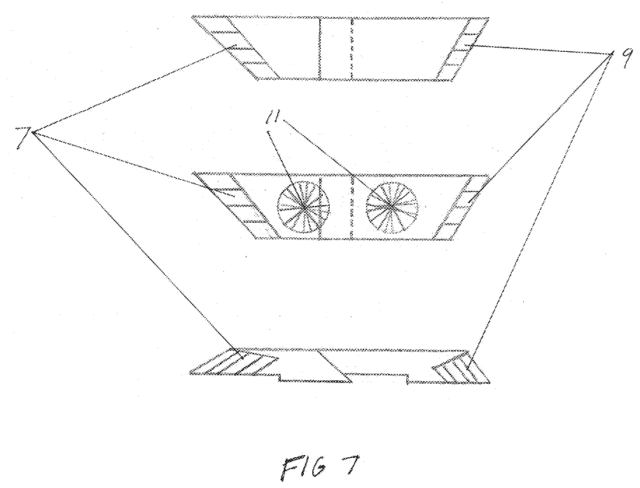

FIG. 7:
7-Intake for EVTOL apparatus
9-Vectoring Thrust for EVTOL apparatus
11-Axial Flux driven turbines

What is claimed is:

1. This aircraft will be able to achieve vertical take-off and landing with the use Axial Flux electric motors that are powered by a low-bypass jet engine.

2. This is achieved through the EVTOL apparatus. The EVTOL apparatus is a self-contained unit capable of generating thrust by use of turbines driven by Axial Flux electric motors. These turbines are spinning at a high rate of speed. The thrust generated is sent to the rear of the apparatus and vectored out.

3. This whole EVTOL apparatus is moveable, thus controlling the thrust is enhanced. Once the aircraft is at a safe elevation the EVTOL apparatus will be moved to the horizontal position and is able to add additional thrust to the aircraft.

4. The unique forward intake design will keep the engine free of foreign objects. During the vertical takeoff and landing process there is the possibility of generating airborne debris on the tarmac. The unique forward intake design will assist and ensure that the low bypass jet turbine is free of any/all foreign objects.

5. This aircraft utilizes a dual wing design. This is used to provide support for the
